(19) United States
(12) Patent Application Publication
(10) Pub. No.: US 2025/0303867 A1
(43) Pub. Date: Oct. 2, 2025

(54) Utility Vehicle

(71) Applicant: Kubota Coporation, Osaka-shi (JP)

(72) Inventors: Shinya Tabata, Osaka (JP); Seigi Aratake, Osaka (JP); Kohta Nakao, Osaka (JP); Kunihiro Yoneguchi, Osaka (JP)

(21) Appl. No.: 18/959,987

(22) Filed: Nov. 26, 2024

(30) Foreign Application Priority Data
Mar. 26, 2024 (JP) 2024-049806

(51) Int. Cl. B60K 37/20; B60R 7/06; B60R 16/023

(52) U.S. Cl. CPC B60K 37/20; B60R 16/023; B60K 2360/61; B60K 2360/84; B60R 7/06

(57) ABSTRACT

A utility vehicle includes a driver section configured to accommodate an occupant, a seating section disposed in the driver section on which seating section an occupant is able to sit, a front cover 12 disposed in the driver section and apart forward from the seating section, and at least one relay connector 33 disposed in the front cover 12 and configured for reaching an in-vehicle electronic device of the utility vehicle. The front cover 12 includes an opening 35 corresponding in position to the at least one relay connector 33 and a maintenance lid 34 configured to expose and block the opening 35.

### CROSS-REFERENCE TO RELATED APPLICATION

This application claims priority to Japanese Patent Application No. 2024-049806 filed Mar. 26, 2024, the disclosure of which is hereby incorporated by reference in its entirety.

### BACKGROUND OF THE INVENTION

### Field of the Invention

The present invention relates to a utility vehicle.

### Description of Related Art

Conventional utility vehicles may, as disclosed in documents such as Japanese Unexamined Patent Application Publication, Tokukai, No. 2023-007623, include an in-vehicle electronic device such as an electronic control unit (ECU) configured to control a component such as an engine.

Maintaining a conventional utility vehicle involves connecting a maintenance device such as a laptop computer to a relay connector under the hood to operate an in-vehicle electronic device for such maintenance work as adjusting a parameter of the ECU. In other words, maintaining an in-vehicle electronic device involves connecting a maintenance device to a relay connector with the hood open. This is troublesome and involves the risk of wetting the relay connector with water such as rainwater. This has left some room for improvement.

### SUMMARY OF THE INVENTION

In view of the above circumstances, the present invention has an object of providing a utility vehicle that allows easy maintenance of an in-vehicle electronic device in rainy weather.

A utility vehicle according to the present invention includes: a driver section configured to accommodate an occupant; a seating section disposed in the driver section on which seating section an occupant is able to sit; a front cover disposed in the driver section and apart forward from the seating section; and at least one relay connector disposed in the front cover and configured for reaching an in-vehicle electronic device of the utility vehicle, the front cover including an opening corresponding in position to the at least one relay connector and a maintenance lid configured to expose and block the opening.

The utility vehicle includes a relay connector in the front cover. This prevents the relay connector from becoming wet with water, as the front cover prevents something inside it from easily becoming wet with rain water. The utility vehicle also includes a maintenance lid attached to the front cover. The maintenance lid is easily openable and closable as compared to the hood, and allows a worker to easily connect a maintenance device to the relay connector.

Some utility vehicles include a roof or the like for the driver section to allow a worker to perform maintenance work under the roof while suitably avoiding rain water.

The utility vehicle may preferably be configured such that the at least one relay connector includes a plurality of relay connectors corresponding in position to the opening.

With the above configuration, the two or more relay connectors are all positioned in correspondence with the opening. This allows a worker to maintain two or more in-vehicle electronic devices efficiently.

The utility vehicle may preferably be configured such that the seating section includes: a driver's seat for an occupant who drives the utility vehicle to sit on; and a passenger's seat lateral to the driver's seat, the utility vehicle further includes a steering wheel forward of the driver's seat, and the maintenance lid is at a lateral portion of the front cover relative to a body of the utility vehicle which lateral portion is proximate to the steering wheel.

With the above configuration, the maintenance lid is not easily accessible to an occupant on the passenger's seat. This prevents the occupant from unintentionally removing the maintenance lid.

The utility vehicle may preferably be configured such that the maintenance lid is below the steering wheel.

With the above configuration, the maintenance lid is not easily accessible to an occupant on the passenger's seat as well as an occupant on the driver's seat. This prevents the occupants from unintentionally removing the maintenance lid.

The utility vehicle may preferably be configured such that the lateral portion is laterally outward of a steering shaft of the steering wheel relative to the body.

With the above configuration, the maintenance lid and the opening are easily accessible to a worker outside the utility vehicle. This allows a worker to connect a maintenance device to a relay connector regardless of whether the worker is inside or outside the utility vehicle.

The utility vehicle may preferably be configured such that the front cover includes a sloped portion sloped downward toward a front, and the maintenance lid is at the sloped portion.

With the above configuration, the opening faces downward. This suitably prevents rain water from entering the opening.

### BRIEF DESCRIPTION OF THE DRAWINGS

FIG. 1 is a side view of a utility vehicle.

FIG. 2 is a plan view of a steering section.

FIG. 3 is a rear view of a steering section with a lid of a container box in the open state.

FIG. 4 is a rear view of a steering section with a lid of a container box in the closed state.

FIG. 5 is a front view of a container box.

FIG. 6 is a perspective view of a lid of a container box.

FIG. 7 is a side view of a lid of a container box in the open state.

FIG. 8 is a side view of a lid of a container box in the closed state.

FIG. 9 is a diagram illustrating an example control configuration for braking operation.

FIG. 10 is a perspective view of a maintenance lid.

### DESCRIPTION OF THE INVENTION

The description below deals with an embodiment of the present invention with reference to drawings. Unless otherwise specified, the description below uses terms such as “front” and “forward” to refer to the direction indicated with arrow F in the drawings, terms such as “back” and “backward” to refer to the direction indicated with arrow B in the drawings, terms such as “left” and “leftward” to refer to the direction indicated with arrow L in the drawings, terms such as “right” and “rightward” to refer to the direction indicated with arrow R in the drawings, terms such as “above” and “upward” to refer to the direction indicated with arrow U in the drawings, and terms such as “below” and “downward” to refer to the direction indicated with arrow D in the drawings.

### Overall Configuration of Utility Vehicle

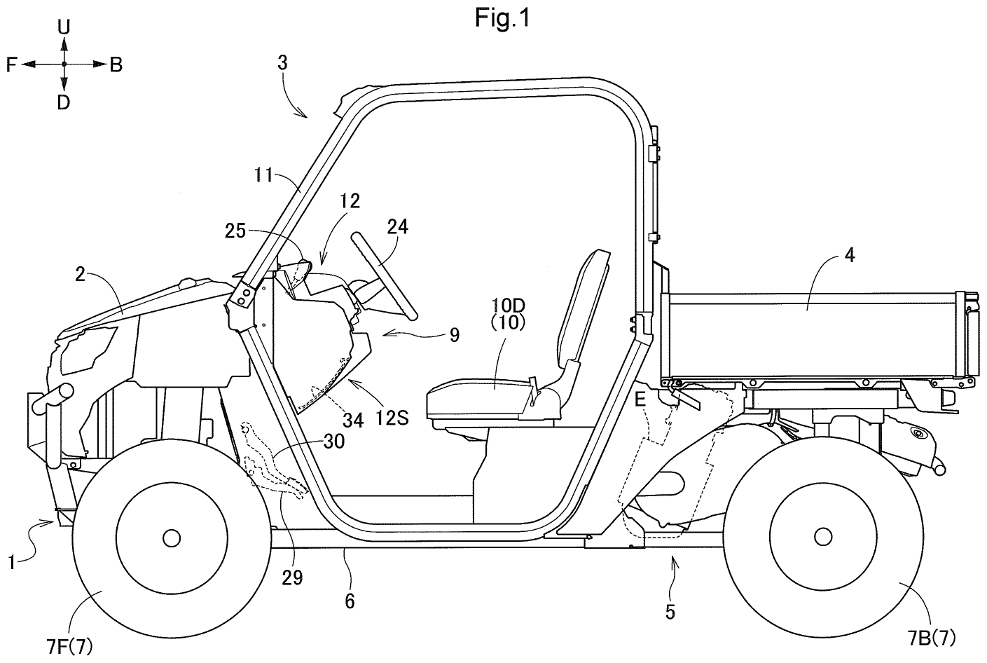

The description below deals with a utility vehicle as the present embodiment. As illustrated in FIG. 1, the utility vehicle includes a body 1, a hood 2, a driver section 3 configured to accommodate occupants, a dump-type carrier box 4, a water-cooling engine E, and a transmission section 5. The body 1 includes a body frame 6 and is provided with a travel device 7.

The travel device 7 includes a pair of left and right front wheels 7F drivable and capable of being turned and a pair of left and right rear wheels 7B drivable and incapable of being turned. The travel device 7 has a drive mode switchable between a two-wheel drive mode, in which only the rear wheels 7B are driven, and a four-wheel drive mode, in which both the front wheels 7F and the rear wheels 7B are driven.

The driver section 3 includes a steering section 9, a seating section 10, and a roll-over protective structure (ROPS) 11 for protecting occupants. The carrier box 4 is backward of the driver section 3.

### Steering Section

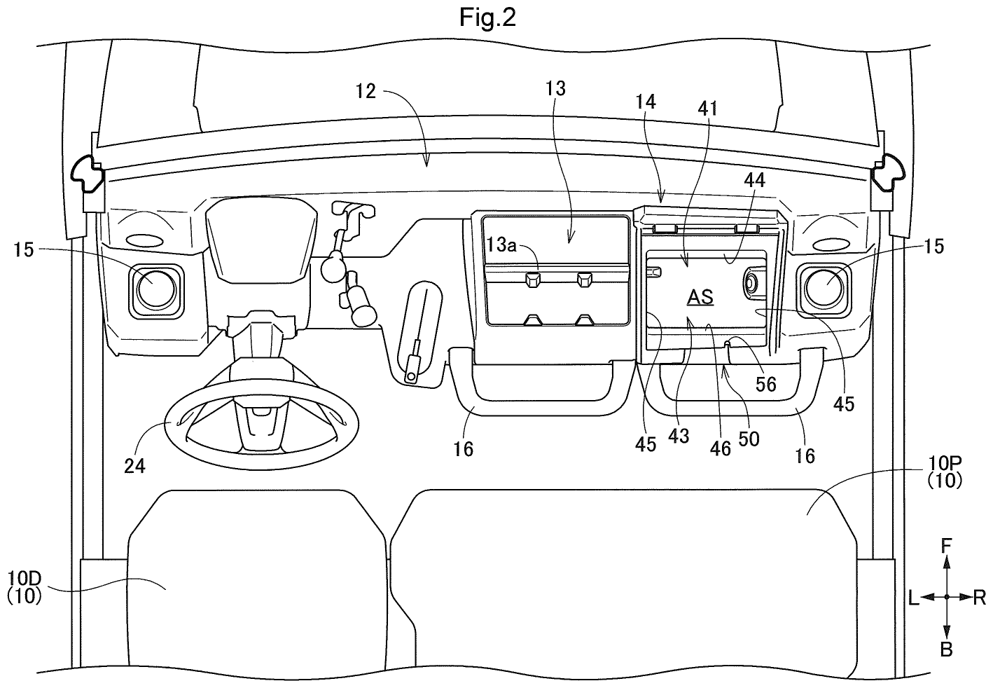

As illustrated in FIGS. 1 and 2, the steering section 9 includes a front cover 12 apart forward from the seating section 10, a steering wheel 24 for use to turn the front wheels 7F, an accelerator pedal 29 for use to adjust the travel speed, a brake pedal 30 for use to brake the utility vehicle, and operation members such as a shift lever 25 for use to shift gears.

The seating section 10 for the present embodiment includes a driver's seat 10D and a passenger's seat 10P lateral to the driver's seat 10D. The driver's seat 10D is disposed on the left side relative to the body and is for an occupant who drives the utility vehicle (hereinafter also referred to as “driver”). The passenger's seat 10P for the present embodiment is a seat on which two occupants are able to sit.

The steering wheel 24 is forward of the driver's seat 10D and is connected to the upper end of a steering shaft (not illustrated in the drawings) extending obliquely upward through an opening (not illustrated in the drawings) in a portion of the front cover 12 which portion is forward of the driver's seat 10D.

As illustrated in FIGS. 2 to 4, the utility vehicle includes at a portion of the front cover 12 which portion is forward of the passenger's seat 10P a glove compartment 13 for storing objects such as small things and a container box 14. The utility vehicle also includes a pair of drink holders 15 at respective laterally opposite end portions of the front cover 12 and a pair of handrails 16 forward of respective (two) portions of the passenger's seat 10P on which portions occupants are able to sit.

### Glove Compartment

As illustrated in FIG. 2, the glove compartment 13 includes a lateral partition plate 13a that divides the glove compartment 13 into a front portion and a back portion each configured to contain an object.

### Container Box

As illustrated in FIGS. 2 to 4, the container box 14 includes a container section 41 and a lid 42. The container section 41 has a container space AS and an opening 43. The lid 42 is switchable between an open state, in which the lid 42 exposes the opening 43, and a closed state, in which the lid 42 blocks the opening 43 to cover the container space AS from above.

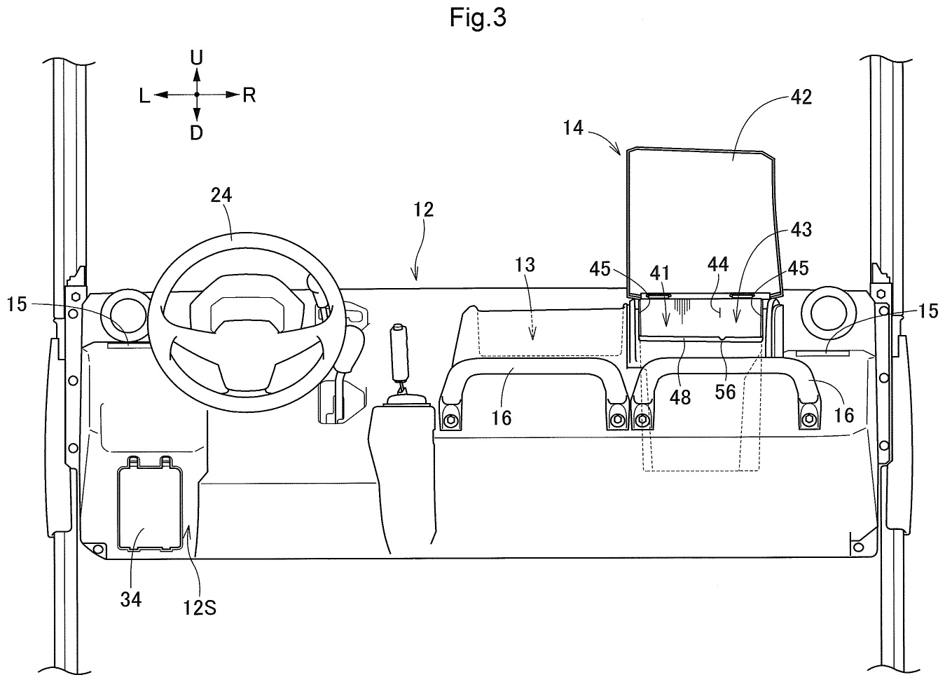

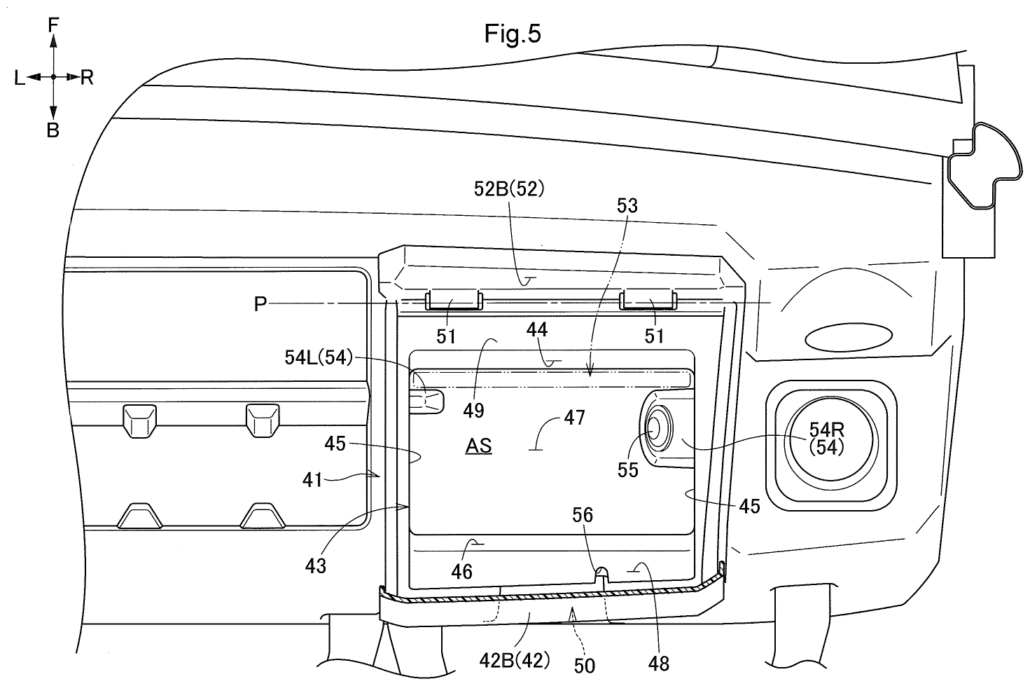

As illustrated in FIGS. 3 and 5, the container section 41 allows an occupant to reach the container space AS through the opening 43 to put an object into the container space AS and take an object out of the container space AS. The container section 41 includes as inner walls a front wall 44, a pair of left and right lateral walls 45, a back wall 46, and a floor 47 to define the container space AS.

The container section 41 includes a back edge portion 48 extending backward from the upper edge of the back wall 46 relative to the body and including an outlet 56 described later.

The opening 43 is defined by the respective upper edges of the front and lateral walls 44 and 45 and the back edge of the back edge portion 48. The back wall 46 has an upper end below the respective upper ends of the front and lateral walls 44 and 45, so that the opening 43 allows an occupant on the seating section 10 to easily reach the container space AS.

As illustrated in FIG. 5, the container section 41 has a groove 49 opposite to the container space AS across the respective upper edges of the front and lateral walls 44 and 45. The groove 49 is configured to receive, for example, water having fallen onto the front cover 12 and flown toward the container box 14. This prevents water or the like from entering the container space AS.

As illustrated in FIGS. 2 and 5, the container section 41 has a depression 50 below the back edge portion 48 to allow an occupant to insert their hand to hold an edge of the lid 42 when the lid 42 is in the closed state.

### Lid

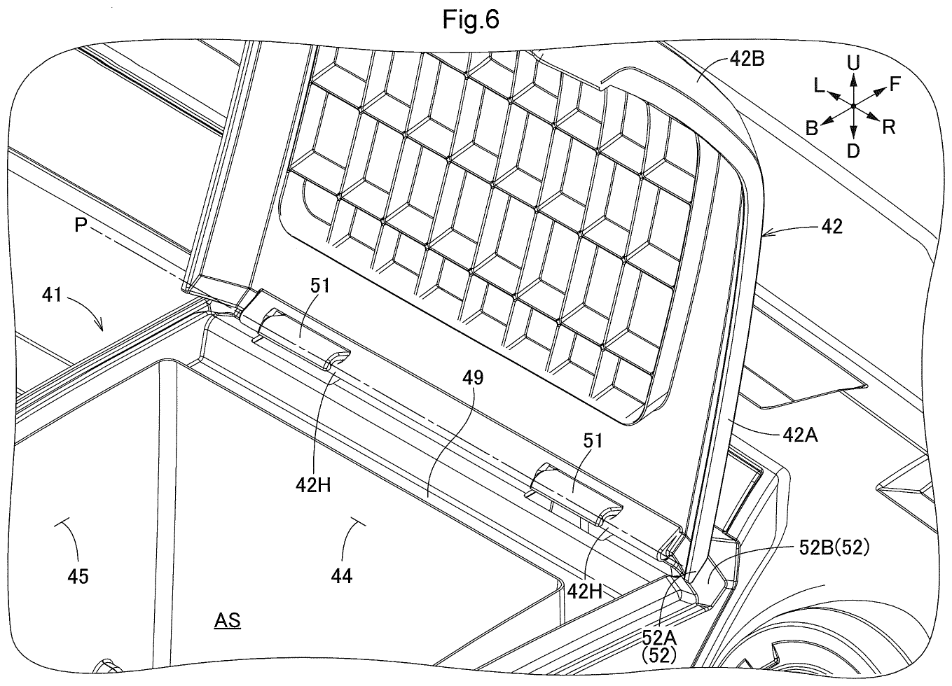

As illustrated in FIGS. 5 and 6, the container section 41 includes a swing holder 51 at a front edge of the opening 43, specifically, forward of the groove 49. The lid 42 includes a hinge 42H engaged with the swing holder 51 so that the lid 42 is held by the swing holder 51 in such a manner as to be swingable about a swing axis P. This allows the lid 42 to swing about the swing axis P into the open state and the closed state.

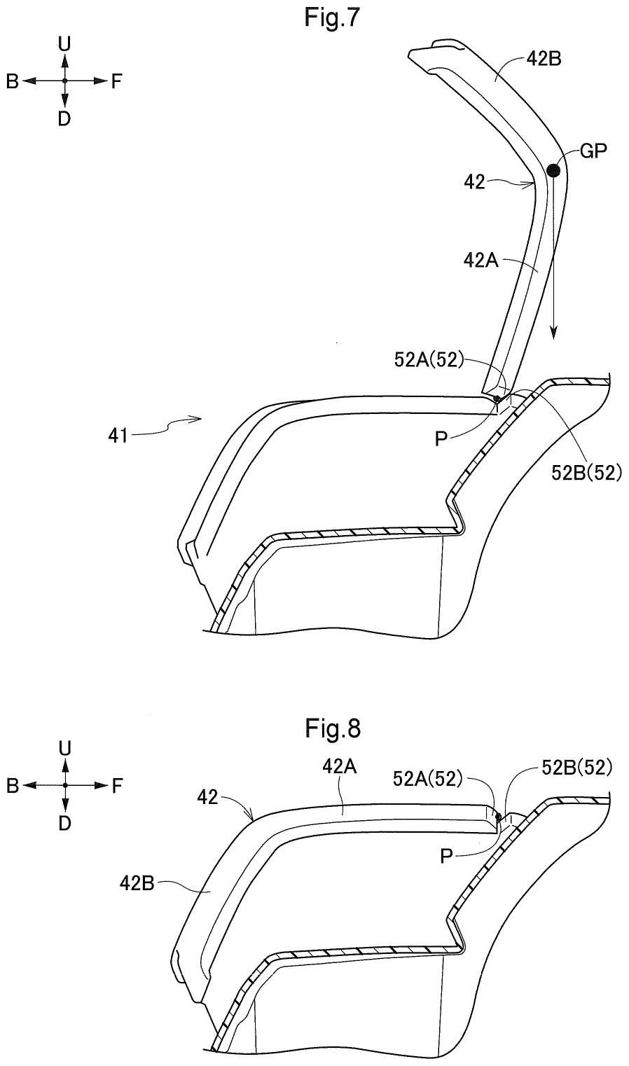

As illustrated in FIGS. 7 and 8, the lid 42 includes an upper face portion 42A configured to face upward when the lid 42 is in the closed state and a back face portion 42B configured to face backward when the lid 42 is in the closed state. With this configuration, the lid 42 is shaped to fit with the upper edge of the container section 41, that is, the opening 43 (see FIG. 5). The lid 42 is configured to cover the groove 49 (see FIG. 5) as well as the opening 43.

The upper face portion 42A has a sloped face 52A at an edge proximate to the swing axis P. The sloped face 52A is so sloped that the edge becomes thinner toward its end. The container section 41 also has a sloped face 52B at a portion proximate to the swing axis P. The sloped face 52B is so sloped downward toward the lid 42 (or the swing axis P). In other words, the sloped faces 52A and 52B are opposite to each other across the swing axis P, and have respective planes that cross each other in a V shape as viewed along the swing axis P when the lid 42 is in the closed state.

Swinging the lid 42 from the closed state to the open state also swings the sloped face 52A and brings the sloped face 52A into contact with the sloped face 52B. In the open state, the lid 42 has a center of gravity GP in the direction of the swing for the open state relative to the swing axis P (that is, forward of the swing axis P) in the front-back direction of the body (that is, in a plan view) to be held in position. The sloped faces 52A and 52B constitute a holding mechanism 52 for holding the lid 42 in its open state.

### Holder

As illustrated in FIG. 5, the container section 41 includes in the container space AS a holder 53 for holding, for example, a document.

The holder 53 includes a pair of left and right protrusions 54 protruding from the respective lateral walls 45 of the container section 41 toward the lateral center relative to the body and integral with the respective lateral walls 45.

The protrusions 54 are in a front portion of the container space AS relative to the body, and extend along the depth of the container space AS. With this configuration, the protrusions 54 serve together with the front wall 44 to define a space as the holder 53 therebetween and allow, for example, a document to be inserted therein from above, so that the protrusions 54 and the front wall 44 hold the document.

The present embodiment is configured such that the right protrusion 54R is larger in the front-back direction than the left protrusion 54L. The right protrusion 54R has an upper end portion provided with a socket 55 for connecting a terminal (not illustrated in the drawings) of a cable or the like to an in-vehicle DC power source.

### Outlet

As illustrated in FIGS. 3 and 5, the back edge portion 48 of the container section 41 includes an outlet 56 for letting a cable connected to the socket 55 out of the container section 41.

The outlet 56 is in the form of a cutout disposed in the back edge portion 48 to allow a cable to extend therethrough.

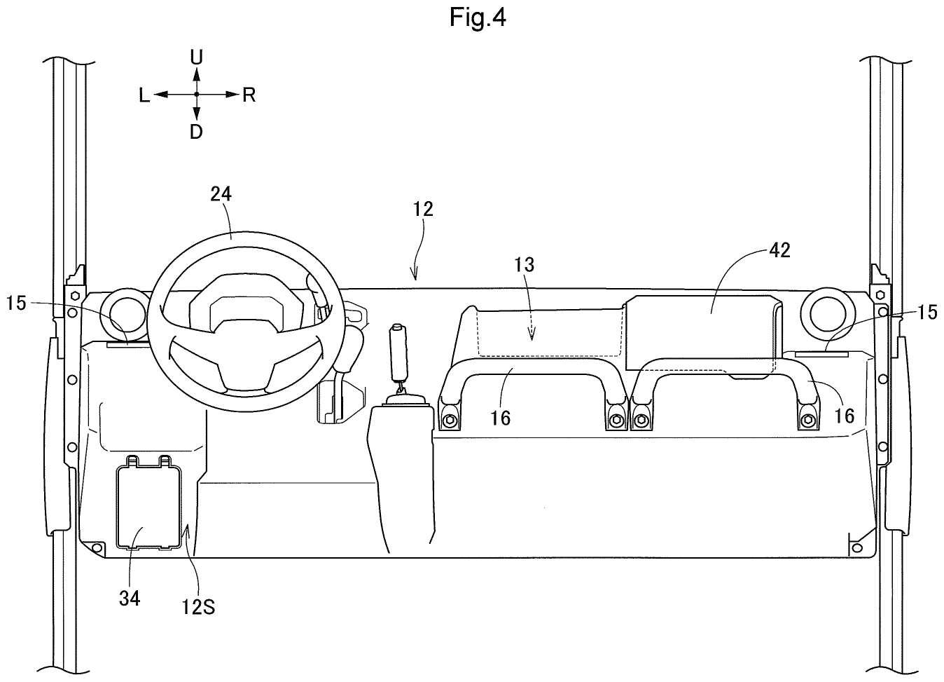

As illustrated in FIG. 5, when the lid 42 is in the closed state, the lid 42 covers the outlet 56, and the back face portion 42B is backward of the outlet 56. As illustrated in FIGS. 3 and 4, the lid 42, in the closed state, has a lower end below the outlet 56. The outlet 56 is at a portion of the edge of the opening 43 which portion is opposite to the swing axis P. This configuration allows the lid 42 to block the outlet 56 when the lid 42 is in the closed state and to expose the outlet 56 when the lid 42 is in the open state.

As illustrated in FIG. 5, the outlet 56 corresponds in position to the depression 50. With a cable extending through the outlet 56 out of the container section 41, the depression 50 allows the cable to extend therethrough out of the container box 14 even when the lid 42 is in the closed state.

### Accelerator Pedal and Brake Pedal

As illustrated in FIG. 1, the accelerator pedal 29 and the brake pedal 30 are forward of the driver's seat 10D and below the steering wheel 24, and are arranged laterally. The accelerator and brake pedals 29 and 30 are configured to be pushed with the driver's foot to adjust the travel speed and the braking force, respectively, in accordance with the amount of the push.

### Controlling Travel Speed and Braking Operation

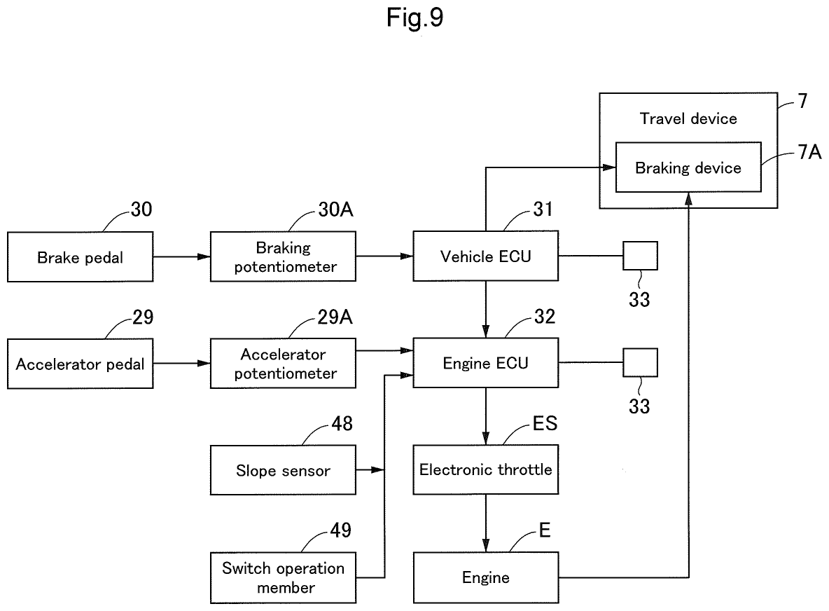

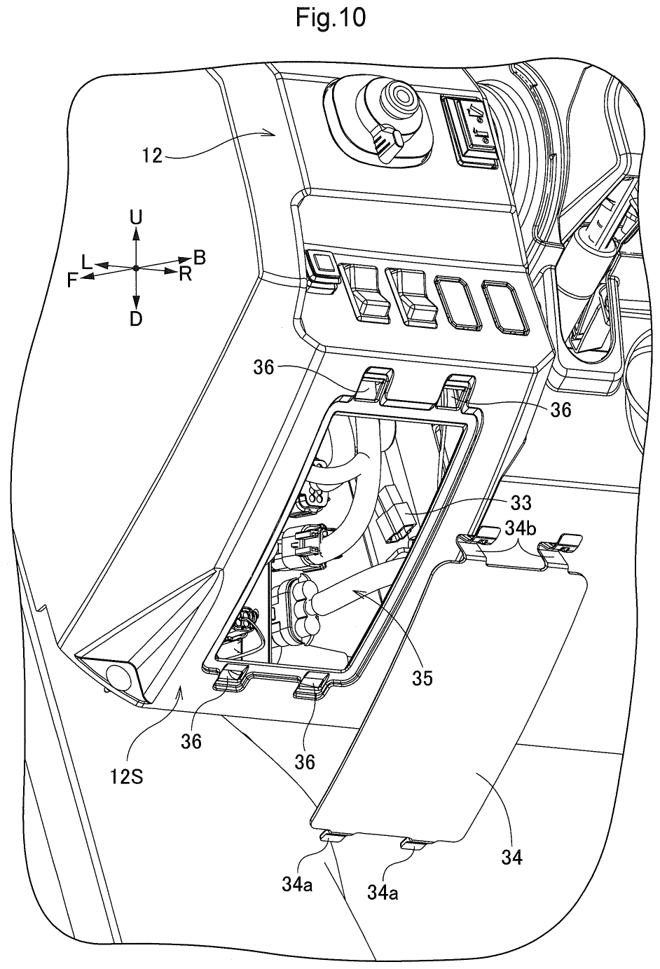

The description below deals with how to control the travel speed and the braking operation with reference to FIGS. 1 and 9.

The travel device 7 includes a braking device 7A configured to, in response to the brake pedal 30 being pushed, brake the utility vehicle by slowing the rotation of the travel device 7 to exert braking action on the travel device 7.

The brake pedal 30 is provided with a braking potentiometer 30A configured to detect the amount of an operation of the brake pedal 30.

The utility vehicle includes a vehicle electronic control unit (ECU) 31 configured to control the braking device 7A. Specifically, the vehicle ECU 31 receives from the braking potentiometer 30A a signal indicative of the amount of an operation of the brake pedal 30 and transmit to the braking device 7A a braking control signal corresponding to the amount of the operation. The braking device 7A brakes the travel device 7 in response to the braking control signal.

The utility vehicle travels at a travel speed adjusted with use of motive power that the engine E transmits to the travel device 7 through the transmission section 5. The utility vehicle includes an electronic throttle ES (which is a motive power adjusting device) operable with use of an accelerator pedal 29. The engine E outputs motive power under control based on adjustment of the amount of air to the engine E in accordance with the degree of opening of the electronic throttle ES.

The accelerator pedal 29 is provided with an accelerator potentiometer 29A configured to detect the amount of an operation of the accelerator pedal 29.

The utility vehicle includes an engine ECU 32 configured to control the engine E. Specifically, the engine ECU 32 receives from the accelerator potentiometer 29A a signal indicative of the amount of an operation of the accelerator pedal 29 and transmit to the electronic throttle ES an accelerator control signal corresponding to the amount of the operation. The electronic throttle ES adjusts its degree of opening in accordance with the accelerator control signal to adjust the amount of air to the engine E. With this configuration, pushing the accelerator pedal 29 adjusts the amount of motive power from the engine E to the travel device 7 in accordance with the amount of the operation of the accelerator pedal 29 to adjust the number of revolutions of the travel device 7 for adjustment of the travel speed.

### Maintenance Lid

As illustrated in FIG. 10, the utility vehicle includes under the front cover 12 two or more relay connectors 33 each for reaching an in-vehicle electronic device such as the vehicle ECU 31 or the engine ECU 32. As illustrated in FIG. 9, the relay connectors 33 for the present embodiment serve to reach the vehicle ECU 31 and the engine ECU 32 as in-vehicle electronic devices. The relay connectors 33 may alternatively serve to reaching in-vehicle electronic devices other than or in addition to the vehicle ECU 31 and the engine ECU 32.

As illustrated in FIG. 10, the front cover 12 has an opening 35 corresponding in position to the relay connectors 33 and a maintenance lid 34 configured to expose and block the opening 35.

As illustrated in FIGS. 3 and 4, the maintenance lid 34 is at a lateral portion of the front cover 12 relative to the body which lateral portion is proximate to the steering wheel 24.

As illustrated in FIGS. 1, 3, 4, and 10, the front cover 12 includes a sloped portion 12S sloped downward toward the front. The sloped portion 12S is laterally outward (that is, to the left) of the steering wheel 24 relative to the body and below the steering wheel 24. The maintenance lid 34 is at the sloped portion 12S.

The front cover 12 has an opening 35 corresponding in position to the relay connectors 33. A maintenance worker removes the maintenance lid 34 to expose the opening 35 and connects a maintenance device such as a laptop computer to a relay connector 33 through the opening 35 for maintenance of in-vehicle electronic devices such as the vehicle ECU 31 and the engine ECU 32.

The maintenance lid 34 includes two locking sections 34a and two hook sections 34b, whereas the front cover 12 includes four locking holes 36. This configuration allows a maintenance worker to lock the locking sections 34a in two of the locking holes 36 and insert the hook sections 34b into the other two locking holes 36 to lock the hook sections 34b therein for attachment of the maintenance lid 34 to the opening 35. The above configuration also allows a maintenance worker to unlock the hook sections 34b for detachment of the maintenance lid 34 from the opening 35.

### Alternative Embodiments

The description below deals with example alternatives to the embodiment described above.
(1) The embodiment described above is an example in which the lid 42 is swingable about a swing axis P forward of the opening 43. The present invention is, however, not limited to such a configuration. For instance, the lid 42 may be swingable about a swing axis P backward of the opening 43. The lid 42 may, in that case, have a center of gravity GP backward of the swing axis P when the lid 42 is in the open state.
(2) The embodiment described above is an example in which the lid 42 has a sloped face 52A, the container section 41 has a sloped face 52B, and the sloped faces 52A and 52B are in contact with each other when the lid 42 is in the open state. The present invention is, however, not limited to such a configuration. For instance, the utility vehicle may include (i) a member separate from the lid 42 which member is in contact with the sloped face 52B when the lid 42 is in the open state or (ii) a member separate from the container section 41 which member is in contact with the sloped face 52A when the lid 42 is in the open state.
(3) The embodiment described above is an example in which the container section 41 is integral with the front cover 12. The present invention is, however, not limited to such a configuration. The container section 41 may be separate from the front cover 12.
(4) The embodiment described above is an example in which the outlet 56 is covered by the lid 42 when the lid 42 is in the closed state. The present invention is, however, not limited to such a configuration. The outlet 56 may remain exposed regardless of whether the lid 42 is in the open state or the closed state.
(5) The embodiment described above is an example in which the swing axis P is at a front edge of the opening 43 in the container section 41, and the outlet 56 is at a portion of the edge of the opening 43 which portion is opposite to the swing axis P. The present invention is, however, not limited to such a configuration. The outlet 56 may be at a portion of the edge of the opening 43 at which portion the swing axis P is present.
(6) The outlet 56 may be provided with a cushion.
(7) The embodiment described above is an example in which the holder 53 includes a pair of left and right protrusions 54 protruding toward the lateral center relative to the body and integral with the respective lateral walls 45. The present invention is, however, not limited to such a configuration. For instance, the holder 53 may include a single protrusion 54 on the left or right.
(8) The embodiment described above is an example in which the right protrusion 54R has an upper end portion provided with a socket 55. The present invention is, however, not limited to such a configuration. The socket 55 may be at an upper end portion of the left protrusion 54L or at a portion in the container space AS of the container section 41 which portion is other than the protrusions 54.
(9) The embodiment described above is an example in which the protrusions 54 are integral with the respective lateral walls 45. The present invention is, however, not limited to such a configuration. The protrusions 54 may be separate from the lateral walls 45.
(10) The embodiment described above is an example in which the container box 14 is at a portion of the front cover 12. The present invention is, however, not limited to such a configuration. The container box 14 may be, for example, between the driver's seat 10D and the passenger's seat 10P.
(11) The embodiment described above is an example in which the maintenance lid 34 is at a portion of the front cover 12 which portion is lateral relative to the body and proximate to the steering wheel 24. The present invention is, however, not limited to such a configuration. The maintenance lid 34 may be at a portion of the front cover 12 which portion is forward of the passenger's seat 10P.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present invention is not limited to those embodiments, and may be altered as appropriate, as long as such an alteration does not result in a failure to attain an object of the present invention.

### INDUSTRIAL APPLICABILITY

The present invention is applicable to utility vehicles.

### REFERENCE SIGNS LIST

3 Driver section
10 Seating section
10D Driver's seat
10P Passenger's seat
12 Front cover
12S Sloped portion
24 Steering wheel
33 Relay connector
34 Maintenance lid
35 Opening

What is claimed is:

1. A utility vehicle, comprising:
a driver section configured to accommodate an occupant;
a seating section disposed in the driver section on which seating section an occupant is able to sit;
a front cover disposed in the driver section and apart forward from the seating section; and
at least one relay connector disposed in the front cover and configured for reaching an in-vehicle electronic device of the utility vehicle, and
wherein the front cover has an opening corresponding in position to the at least one relay connector and a maintenance lid configured to expose and block the opening.

2. The utility vehicle according to claim 1, wherein:
the at least one relay connector comprises a plurality of relay connectors corresponding in position to the opening.

3. The utility vehicle according to claim 1, wherein:
the seating section comprises:
a driver's seat for an occupant who drives the utility vehicle to sit on; and
a passenger's seat lateral to the driver's seat,
the utility vehicle further comprises a steering wheel forward of the driver's seat, and
the maintenance lid is at a lateral portion of the front cover relative to a body of the utility vehicle which lateral portion is proximate to the steering wheel.

4. The utility vehicle according to claim 3, wherein:
the maintenance lid is below the steering wheel.

5. The utility vehicle according to claim 3, wherein:
the lateral portion is laterally outward of a steering shaft of the steering wheel relative to the body.

6. The utility vehicle according to claim 1, wherein:
the front cover comprises a sloped portion sloped downward toward a front, and the maintenance lid is at the sloped portion.
